(19) United States
(12) Patent Application Publication
(10) Pub. No.: US 2005/0101348 A1
(43) Pub. Date: May 12, 2005

(54) Mobile phone and camera thereof

(75) Inventor: Men-Sheng Wang, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/983,075

(22) Filed: Nov. 5, 2004

(30) Foreign Application Priority Data
Nov. 6, 2003 (TW) TW92131030

(51) Int. Cl. H04N 7/14; H04M 1/00; G02B 9/04

(52) U.S. Cl. 455/556.1; 348/14.02

(57) ABSTRACT

A mobile phone and a camera thereof. The mobile phone comprises a main body, a camera lens disposed in the main body and a lens module having a plurality of optic lenses selectively covering the camera lens. The lens module can slide on a track thereby changing the optic lens covering the lens.

### BACKGROUND OF THE INVENTION

1. Field of the Invention

The present invention relates to a mobile phone, and in particular to a mobile phone provided with a camera and a lens module.

2. Description of the Related Art

Conventional mobile phones are rarely provided with protecting covers for digital camera lens thereof. When higher resolution of the digital camera is needed, protection for the lens is important.

Therefore, an external lens device having a protecting glass is called for. In addition to protection, the lens device may comprise certain filter lenses providing various photo effects, such as magnification (zoom), polarization (brightness) or others.

### SUMMARY OF THE INVENTION

Accordingly, an object of the invention is to provide a mobile phone having a digital camera provided with a lens module to protect the camera lens and provide various photo effects.

The mobile phone of the invention comprises a main body, a camera lens disposed in the main body, a lens module comprising a plurality of optic lenses selectively covering the camera lens.

The lens module can linearly move or rotate on the main body. In linear motion, the mobile phone further comprises a track disposed on the main body for the frame to travel on to change the optic lenses covering the camera lens. The track has a stop and the frame has a latching element contacting the stop to contain the frame on the track. The frame has a plurality of notches and the track further has a tab engaging one of the notches to locate the frame in different positions.

In rotation, the optic lenses are arranged around a predetermined point on the frame, and the frame is rotated around the point to change the optic lenses covering the camera lens. The frame can be a circular plate. The main body has a plurality of notches and the frame has at least one tab engaging one of the notches to locate the frame in different positions.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of the first embodiment of the invention;

FIG. 2a is a front view of the first embodiment of the invention;

FIG. 2b is a schematic view of the first embodiment of the invention showing the optic lenses covering the camera lens;

FIG. 2c is a schematic view of the first embodiment of the invention showing the latching element equipped with a stopper;

FIG. 3 is a schematic view of the second embodiment of the invention;

FIG. 4 is a front view of the second embodiment of the invention showing the lens module and the track; and

FIG. 5 is a schematic view of the second embodiment of the invention showing the frame located on the main body.

### DETAILED DESCRIPTION OF THE INVENTION

### FIRST EMBODIMENT

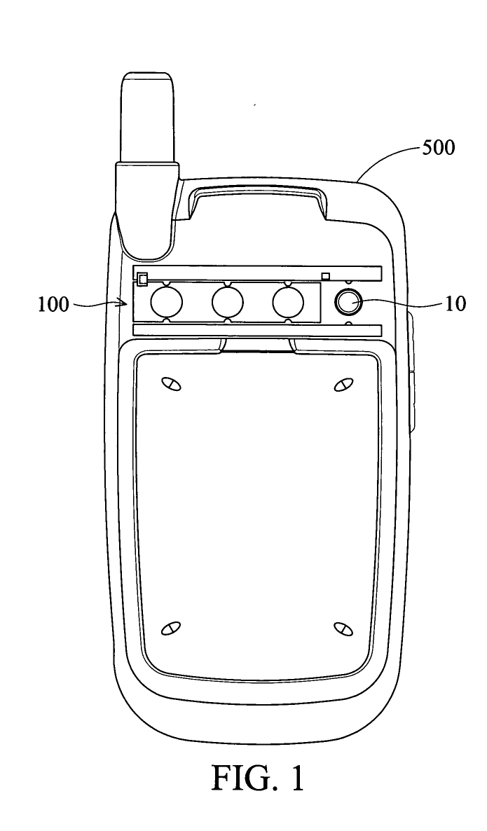

FIG. 1 is a schematic view of a mobile phone of the invention. A main body 500 of the mobile phone is provided with a camera lens 10 and a lens module 100.

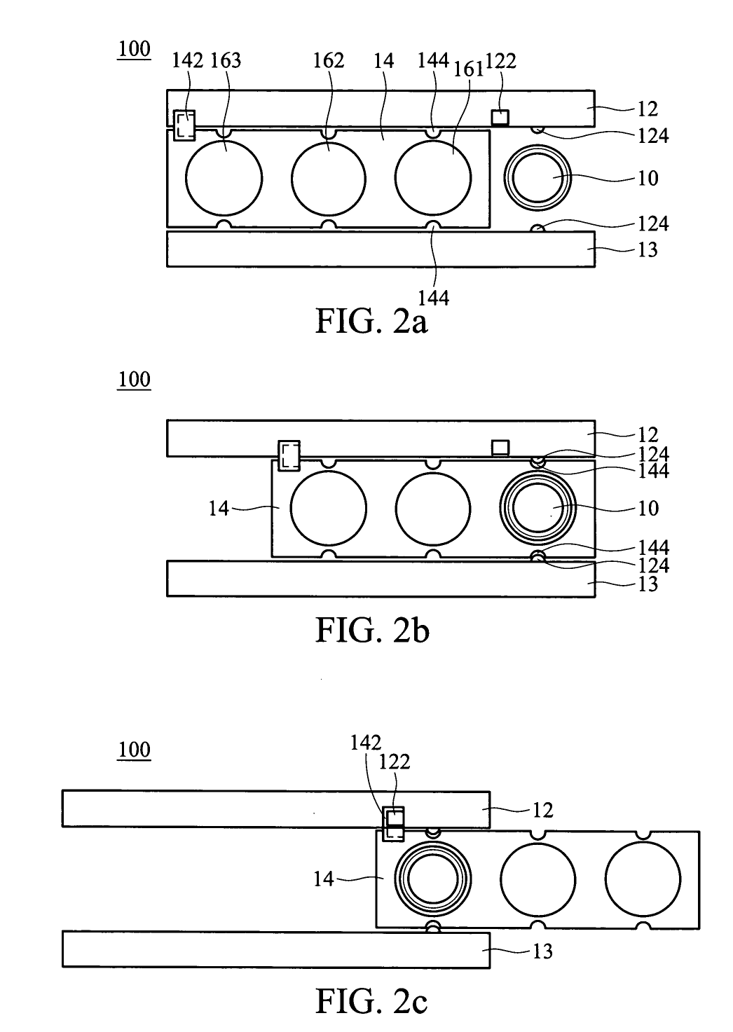

FIG. 2a is a front view of the lens module of the invention. Two tracks 12, 13 are respectively disposed on two sides of the camera lens 10, and a frame 14 accommodating three optic lenses 161, 162, 163 sliding between the two tracks 12, 13. The optic lens 161 is a protecting lens and optic lenses 162 and 163 server other different purposes. Two tabs 124 project from tracks 12, 13 positioned beside the camera lens 10. Two opposite notches 144 are defined beside each of the optic lenses 161, 162, 163. As shown in FIG. 2b, the tab 124 engages with the notch 144 to locate the frame 14 for the intended optic lens on the camera lens 10. In FIG. 2a, a stop 122 is mounted on the track 12 and a latching element 142 formed integrally with the frame 14. As shown in FIG. 2c, the latching element 142 engages the stopper 122 to contain the frame 14 within tracks 12, 13.

### SECOND EMBODIMENT

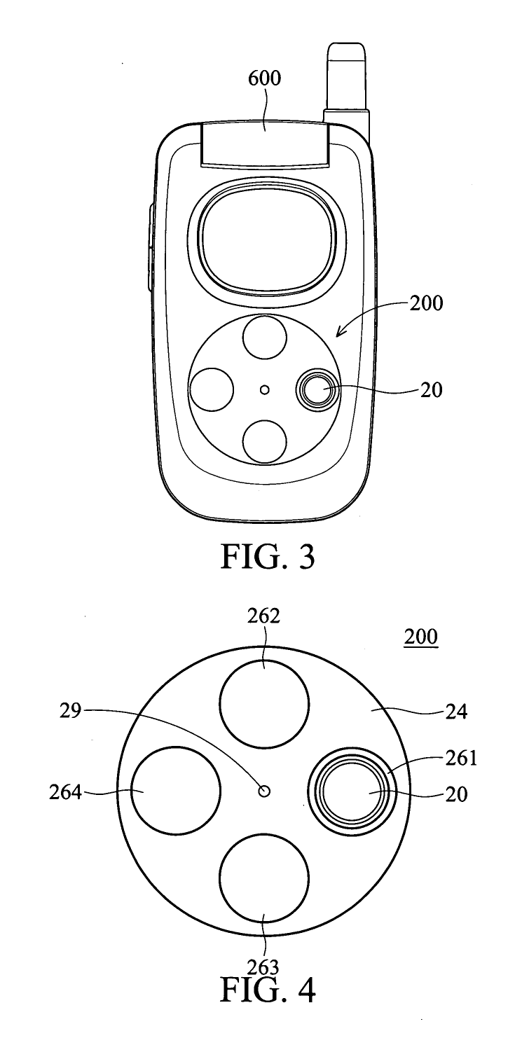

In addition to the linear travel mechanism, a circular plate can also be applied as the frame. As shown in FIG. 3, a main body 600 of a mobile phone is provided with a camera lens 20 and a lens module 200 comprising a circular frame 24. In FIG. 4, the circular frame 24 rotates around an axis 29 around which an opening 261, a protecting lens 262 and filter lenses 263, 264 are arranged. The frame 24 rotates to change optic lenses on the camera lens 20 for different purposes such as protection or various photo effects.

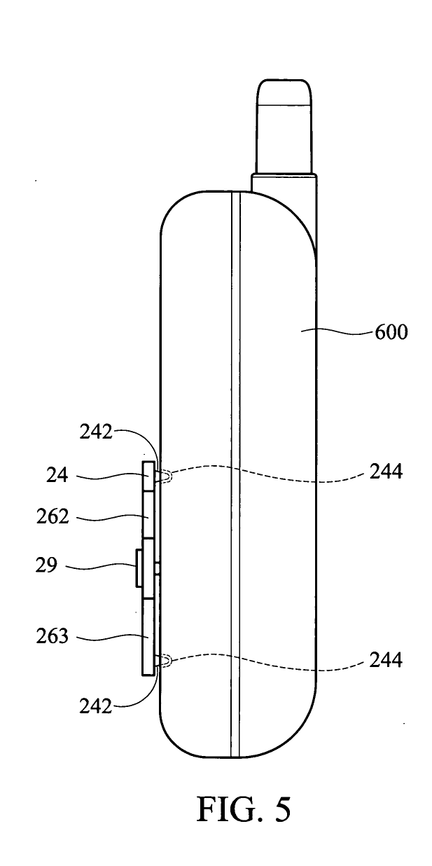

As shown in FIG. 5, the tab 242 engages the notch 244 to locate the frame 24 for the intended optic lens covering the camera lens 20.

The mobile phone of the invention is provided with a lens module sliding on a track or rotating to change optic lenses covering the camera lens to provide protection of the camera lens and various photo effects.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mobile phone, comprising:
a main body;
a camera lens disposed in the main body;
a lens module comprising a plurality of optic lenses selectively covering the camera lens.

2. The mobile phone as claimed in claim 1, wherein the lens module further comprises a frame accommodating the optic lenses.

3. The mobile phone as claimed in claim 2, wherein the lens module moves linearly on the main body.

4. The mobile phone as claimed in claim 2, wherein the lens module rotates on the main body.

5. The mobile as claimed in claim 3 further comprising a track disposed on the main body for the frame to slide thereon to change the optic lenses covering the camera lens.

6. The mobile phone as claimed in claim 5, wherein the track comprises a stop and the frame has a latching element contacting the stop to contain the frame within the track.

7. The mobile phone as claimed in claim 6, wherein the latching element is formed integrally with the frame.

8. The mobile phone as claimed in claim 5, wherein the frame comprises a plurality of notches and the track has a tab engaging one of the notches to locate the frame in different positions.

9. The mobile phone as claimed in claim 6, wherein the frame comprises a plurality of notches and the track has a tab engaging one of the notches to locate the frame in different positions.

10. The mobile phone as claimed in claim 4, wherein the optic lenses are arranged around a predetermined point on the frame, and the frame rotates around the point to change the optic lenses covering the camera lens.

11. The mobile phone as claimed in claim 10, wherein the frame is a circular plate.

12. The mobile phone as claimed in claim 10, wherein the main body comprises a plurality of notches and the frame has at least one tab engaging one of the notches to locate the frame in different positions.

13. A camera disposed in a mobile phone, comprising:
a camera lens disposed in the mobile phone;
a lens module comprising a plurality of optic lenses to selectively cover the camera lens.

14. The camera as claimed in claim 13, wherein the lens module is movable.

15. The camera as claimed in claim 13, wherein the lens module is rotatable.

16. The camera as claimed in claim 14, wherein the lens module comprises a frame accommodating the optic lenses.

17. The camera as claimed in claim 16 further comprising a track disposed on the mobile phone for the frame to slide thereon to change the optic lenses covering the camera lens.

18. The camera as claimed in claim 17, wherein the track comprises a stop and the frame has a latching element contacting the stop to contain the frame within the track.

19. The camera as claimed in claim 18, wherein the latching element is formed integrally with the frame.

20. The camera as claimed in claim 17, wherein the frame comprises a plurality of notches and the track has a tab engaging one of the notches to locate the frame in different positions.

21. The camera as claimed in claim 15, wherein the lens module comprises a frame accommodating the optic lenses.

22. The camera as claimed in claim 21, wherein the optic lenses are arranged around a predetermined point on the frame, and the frame is rotated around the point to change the optic lenses covering the camera lens.

23. The camera as claimed in claim 22, wherein the frame is a circular plate.

24. The camera as claimed in claim 21, wherein the main body comprises a plurality of notches and the frame has at least one tab engaging one of the notches to locate the frame in different positions.
